(19) United States
(12) Patent Application Publication
(10) Pub. No.: US 2011/0074632 A1
(43) Pub. Date: Mar. 31, 2011

(54) WIRELESS POSITIONING METHOD AND APPARATUS

(75) Inventors: Geon Min Yeo, Daejeon (KR); Kanghee Kim, Daejeon (KR); Byung-Han Ryu, Daejeon (KR); Hyeong Jun Park, Daejeon (KR)

(73) Assignee: ELECTRONICS AND TELECOMMUNICATIONS RESEARCH INSTITUTE, Daejeon (KR)

(21) Appl. No.: 12/894,740

(22) Filed: Sep. 30, 2010

(30) Foreign Application Priority Data
Sep. 30, 2009 (KR) 10-2009-0093233
Sep. 30, 2010 (KR) 10-2010-0095193

(51) Int. Cl. G01S 1/24; G01S 3/02

(52) U.S. Cl. 342/387; 342/458

(57) ABSTRACT

A wireless positioning method of a receiver is provided. Signals are received from a plurality of transmitters, propagation taps of the plurality of transmitters received from the plurality of transmitters are determined, respectively, the distance between the receiver and each of the transmitters is calculated, respectively, the weight of each of the transmitters is calculated by using each of the propagation delay tap, the distance is adjusted by using the weight of each of the transmitters, and an area, in which circles away by the adjusted distances between the receiver and each of the transmitters on the basis of each of the transmitters overlap with each other, is estimated as the location of the receiver. Thus, an error of wireless positioning according to a propagation environment can be reduced.

### CROSS-REFERENCE TO RELATED APPLICATION

This application claims priority to and the benefit of Korean Patent Application No. 10-2009-0093233 and 10-2010-0095193 filed in the Korean Intellectual Property Office on Sep. 30, 2009 and Sep. 30, 2010, the entire contents of which are incorporated herein by reference.

### BACKGROUND OF THE INVENTION

(a) Field of the Invention

The present invention relates to wireless positioning method and apparatus and, more particularly, to a method and apparatus for measuring the location of a terminal on the basis of a type of propagation delay.

(b) Description of the Related Art

A wireless positioning technique is measuring the location of a terminal in a wireless communication system, and recently, as demand for a location-based service (LBS) is increasing, an applied sector of the wireless positioning technique is expanding. In particular, the wireless positioning technique is getting popular according to the growing demand for a technique of detecting a situation or the location of a user and providing an appropriate service to the user.

A global positioning system (GPS), a representative positioning technique, provides positioning results of a high level of accuracy, but with a problem in that a terminal in an indoor area is not able to receive a GPS signal and it can receive the GPS signal only when a GPS receiver is mounted in the terminal.

Thus, a received signal strength indicator (RSSI) method and a time difference of arrival (TDOA) method are considered as alternative wireless positioning techniques. The RSSI method is acquiring location information by using the strength of a reception signal. According to the RSSI method, location information can be acquired because it has a simple structure, but an excessive error occurs due to a path loss.

The TDOA method is acquiring location information by using the time differences of arrival. According to the TDOA method, time synchronization between a receiver and a transmitter are not required, but transmitters must be necessarily synchronized in time.

The foregoing wireless positioning techniques, namely, the GPS, the RSSI method, and the TDOA method, have a problem in that they lack an ability of providing accurate positioning results in a non-line of sight (NLOS) environment or an environment in which a channel state is poor. Thus, a method for providing accurate positioning results reflecting a signal propagation environment is required.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a wireless positioning method and apparatus in consideration of a type of propagation delay. In particular, the present invention provides a wireless positioning method and apparatus having advantages of minimizing a positioning error in a non-line of sight (NLOS) environment.

An exemplary embodiment of the present invention provides a wireless positioning method of a receiver, including: receiving signals from a plurality of transmitters; determining a propagation delay tap of each of the plurality of transmitters received from the plurality of transmitters, respectively; calculating the distance between the receiver and each of the transmitters, respectively; calculating the weight of each of the transmitters by using each of the propagation delay taps; adjusting each of the distances by using each of the weights; and estimating an area, in which circles away by the adjusted distances between the receiver and each of the transmitters on the basis of each of the transmitters overlap with each other, as the location of the receiver.

Another embodiment of the present invention provides a wireless positioning method of a receiver, including: receiving signals from a plurality of transmitters; determining a propagation delay tap of each of the plurality of transmitters received from the plurality of transmitters; calculating the distance between the receiver and each of the transmitters, respectively, by using an arrival time of a first reached propagation delay tap among the propagation delay taps of the transmitters; and determining the location of the receiver by using the distance and a delay spread value.

Yet another embodiment of the present invention provides a wireless positioning apparatus of a receiver, including: a signal receiving unit configured to receive signals from a plurality of transmitters; a propagation delay tap determining unit configured to determine propagation delay taps of the plurality of transmitters received from the plurality of transmitters; a distance calculation unit configured to calculate the distance between the receiver and each of the transmitters, respectively; a weight calculation unit configured to calculate the weight of each of the transmitters by using the propagation delay taps; and a location determining unit configured to adjust the distances by using the weights, and estimate an area, in which circles away by the adjusted distances between the receiver and each of the transmitters on the basis of each of the transmitters overlap with each other, as the location of the receiver.

### BRIEF DESCRIPTION OF THE DRAWINGS

FIGS. 1A to 1D are graphs showing types of propagation delay taps.

FIG. 2 illustrates an example of a wireless positioning method of a receiver.

FIGS. 3 and 4 are graphs of delay spreads over distances from propagation delay taps denoting NLOS environments.

FIG. 5 is a schematic block diagram of a wireless positioning apparatus according to an exemplary embodiment of the present invention, and

FIG. 6 is a flow chart illustrating the process of a wireless positioning method according to an exemplary embodiment of the present invention.

FIG. 7 is a view illustrating a method for estimating the location of a receiver by a wireless positioning apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising”, will be understood to imply the inclusion of stated elements but not the exclusion of any other elements.

In the present disclosure, a terminal may be designated as a mobile station (MS), mobile terminal (MT), a subscriber station (SS), a portable subscriber station (PSS), a user equipment (UE), an access terminal (AT), and the like, and include entire or partial functions of the terminal, MS, MT, SS, PSS, UE, AT, and the like.

In the present disclosure, a base station (BS) may be designated as a radio access station (RAS), a Node B, an evolved Node B (eNodeB), a base transceiver station (BTS), a mobile multihop relay (MMR)-BS, and the like, and include the entire or partial functions of the BS, RAS, Node B, eNodeB, BTS, MMR-BS, and the like.

A wireless positioning method and apparatus according to exemplary embodiments of the present invention will now be described with reference to the accompanying drawings.

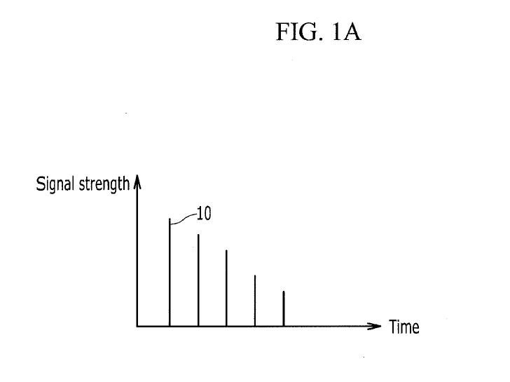

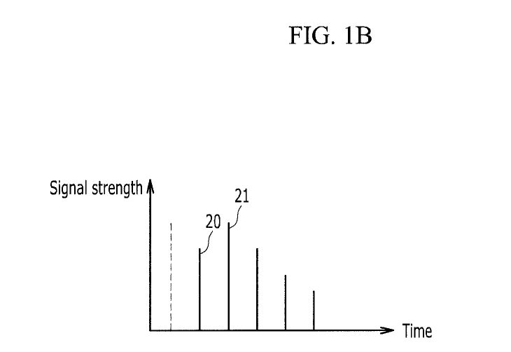

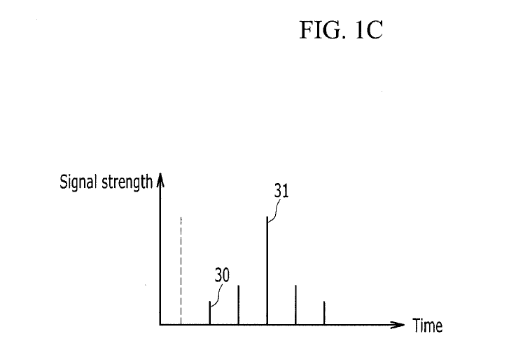

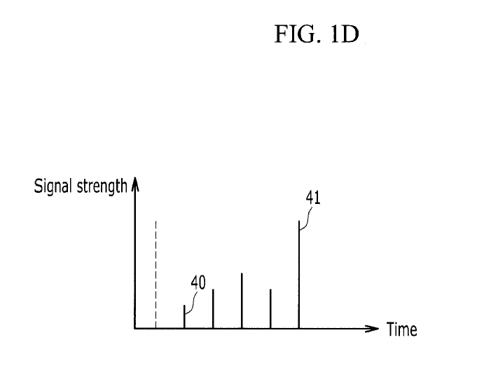

FIGS. 1A to 1D are graphs showing types of propagation delay taps.

A propagation delay tap refers to a signal in a delay spread form after having been transmitted from a transmitter in a multi-path environment. When there is a geographical obstacle between the transmitter and a receiver, multiple paths are formed due to a reflection or diffraction of a signal by the obstacle. Thus, a signal which has been transmitted from the transmitter is delay-spread through the multiple paths.

With reference to FIG. 1A, a signal strength of a propagation tap 10 which has first arrived at the receiver is the greatest. When there is no obstacle between the transmitter and the receiver, a signal, which has been transmitted from the transmitter, can reach the receiver with a high signal strength within a short time. Thus, the type of the propagation delay tap of FIG. 1A may be close to a line of sight (LOS) environment.

With reference to FIG. 1B, a signal strength of a propagation delay tap 21 which has second reached the receiver is the greatest, and a signal strength of a first reached propagation delay tap 20 is smaller than that of the propagation delay tap 21.

With reference to FIG. 1C, a strength of a propagation delay tap 31 which has third reached the receiver is the greatest, and that of a first reached propagation delay tap 30 is smaller than that of the propagation delay tap 31.

With reference to FIG. 1D, a signal strength of a propagation delay tap 41 which has reached the receiver the latest is the greatest, and that of a first reached propagation delay tap 40 is smaller than that of the propagation delay tap 41.

As the type of the propagation delay tap is similar to that of FIG. 1A, the environment between the receiver and the transmitter is close to a line of sight (LOS) environment. As the type of the propagation delay tap is similar to that of FIG. 1D, namely, as an arrival time of the propagation delay tap having the greatest signal strength is delayed, the environment between the transmitter and the receiver is close to a non-line of sight (NLOS) environment.

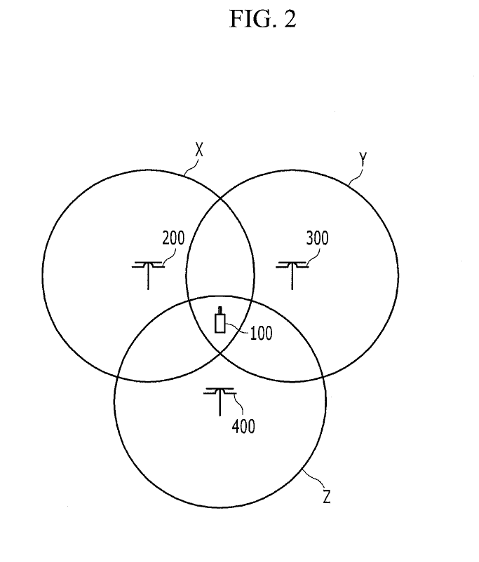

FIG. 2 illustrates an example of a wireless positioning method of a receiver.

With reference to FIG. 2, a receiver 100 estimates its location by using reference signals for wireless positioning transmitted by a plurality of transmitters, e.g., transmitters 200, 300, and 400. It is assumed that the receiver 100 knows about the locations of the transmitters 200, 300, and 400.

The receiver 100 calculates the distance between each of the transmitters 200, 300, and 400 and the receiver 200, respectively, by using an arrival time of a first reached propagation delay tap among the propagation delay taps of the reference signals received from the respective transmitters 200, 300, and 400, and forms circles X, Y, and Z in which the distance between each of the transmitters 200, 300, and 400 and the receiver 100 is the radius based on the center of each of the transmitters 200, 300, and 400. The receiver 100 may estimate an area, in which the circles X, Y, and Z overlap with each other, as the location of the receiver 100.

Meanwhile, as a propagation environment between the receiver and the transmitters is close to the LOS environment, the propagation delay tap reaches the receiver earlier, and as the propagation environment between the receiver and the transmitters is close to the NLOS environment, the propagation delay tap reaches the receiver later. Thus, if the distance between the receiver and the transmitters is calculated by using the arrival time of the propagation delay tap without considering the influence of the propagation environment, a great error would possibly occur in positioning the receiver. Namely, when a propagation environment between the receiver and the respective transmitters is the ideal LOS environment, the circles based on the centers of the respective transmitters meet at one point. Meanwhile, when the propagation environment between the receiver and the respective transmitters is the NLOS environment, an arrival time of the first reached propagation delay tap of a transmitter is later than that of the LOS environment, so the distance between the receiver and each of the transmitters is calculated to be longer than an actual distance, resulting in that the area in which the circles overlap with each other based on the centers of the respective transmitters widens.

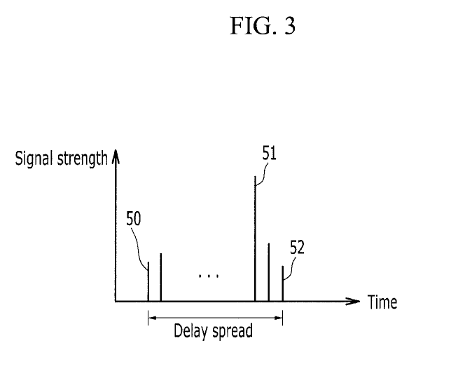

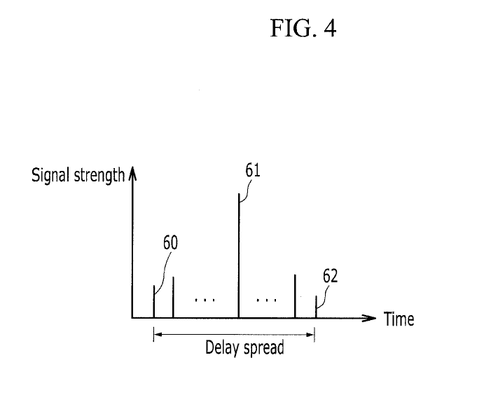

FIGS. 3 and 4 are graphs of delay spreads over distances from propagation delay taps denoting NLOS environments.

With reference to FIGS. 3 and 4, propagation delay taps 51 and 61 having the greatest signal strength are not propagation delay taps 50 and 60 which have first reached. Thus, it can be noted that the propagation environment between the receiver and the transmitters is the NLOS environment.

Meanwhile, when the time differences of arrival between the arrival time of the first reached propagation delay taps 50 and 60 and the arrival time of the latest reached propagation delay taps 52 and 62 are defined as delay spread values, the delay spread value of the case illustrated in FIG. 3 is smaller than that of the case illustrated in FIG. 4. Because the delay spread value increases as the distance between the receiver and the transmitters is longer, it means that the distance between the receiver and the transmitters with respect to the propagation delay taps of FIG. 4 is longer than the distance between the receiver and the transmitters with respect to the propagation delay taps of FIG. 3. A method for determining an accurate location of the receiver by reflecting a delay spread value will now be described.

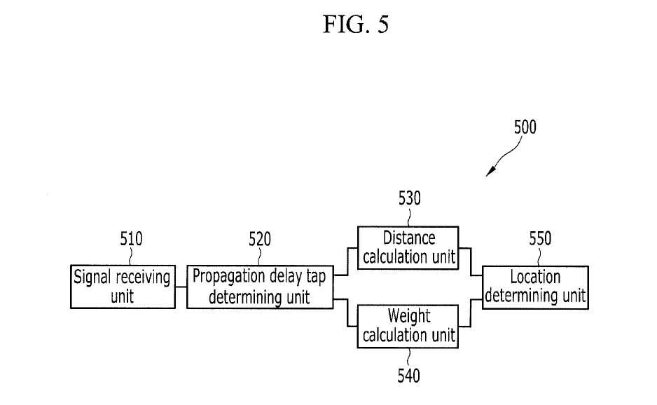

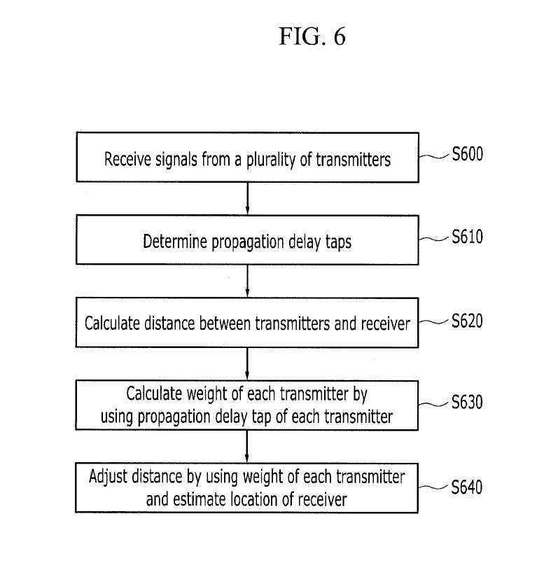

FIG. 5 is a schematic block diagram of a wireless positioning apparatus according to an exemplary embodiment of the present invention, and FIG. 6 is a flow chart illustrating the process of a wireless positioning method according to an exemplary embodiment of the present invention. The wireless positioning apparatus may be a part of the receiver. It is assumed that the wireless positioning apparatus knows about the location of a neighboring transmitter.

With reference to FIG. 5, the wireless positioning apparatus 500 includes a signal receiving unit 510, a propagation delay tap determining unit 520, a distance calculation unit 530, a weight calculation unit 540, and a location estimation unit 550.

With reference to FIGS. 5 and 6, the signal receiving unit 510 receives signals transmitted from a plurality of transmitters (S600). The signals transmitted from the transmitters may be, for example, reference signals for positioning. Hereinafter, a case in which the signal receiving unit 510 receives the reference signals for positioning from the plurality of transmitters will be described as an example,

The propagation delay tap determining unit 520 determines propagation delay taps with respect to signals transmitted from the plurality of transmitters (S610). For example, the propagation delay tap determining unit 520 may determine an arrival time of a first reached propagation delay tap, an arrival time of the latest reached propagation delay tap, and an arrival time of a propagation delay tap having the greatest signal strength. The propagation delay tap determining unit 520 may further determine a propagation environment on the basis of the propagation delay taps. For example, the propagation delay tap determining unit 520 selects a propagation delay tap having the greatest signal strength from among the propagation delay taps of the respective transmitters, and when the selected propagation delay tap is the first reached propagation delay tap, the propagation delay tap determining unit 520 determines that the propagation environment of the corresponding transmitter is an LOS environment. Meanwhile, if the selected propagation delay tap is not the first reached propagation delay tap, the propagation delay tap determining unit 520 determines that the propagation environment of the corresponding transmitter is an NLOS environment.

The distance calculation unit 530 calculates the distance between each of the transmitter and the receiver (S620). The distance between each of the transmitters and the receiver may be calculated by using an arrival time of the first reached propagation delay tap among the propagation delay taps of the respective transmitters.

The weight calculation unit 540 calculates the weight of each of the transmitters by using the propagation delay tap of each of the transmitters (S630). For example, the weight of each of the transmitters may be calculated by using Equation 1 shown below:

Wᵢ=Dᵢ/(D₁+D₂+ . . . +D_{N}) (Equation 1)

Here, Dᵢ is a delay spread value of a transmitter I, N is a total number of transmitters that transmit the reference signal or the number of transmitters in the NLOS environment among transmitters that transmit the reference signal to the receiver. The delay spread value refers to the difference between the arrival time of the first reached propagation delay tap and the latest reached propagation delay tap. For another example, the weight of each of the transmitters may be calculated by using Equation 2 shown below:

Wi=F(Dᵢ,Sᵢ) (Equation 2)

Here, Sᵢ is a signal strength of a propagation delay tap of a transmitter i. Namely, the weight may be calculated by using the delay spread value of each of the transmitters and the signal strength of the propagation delay tap.

Next, the location estimation unit 550 adjusts the distance between the receiver and each of the transmitters by using the weight of each of the transmitters, and estimates the location of the receiver (S640). For example, the location estimation unit 550 may reduce the distance between the receiver and each of the transmitters calculated in step S620 in a weight ratio. The location estimation unit 550 may estimate the area, in which circles away by the distance between the receiver and each of the transmitters on the basis of the center of each of the transmitters overlap with each other, as the location of the receiver. A detailed method of adjusting the distance between the receiver and each of the transmitter and estimating the location of the receiver will be described as follows.

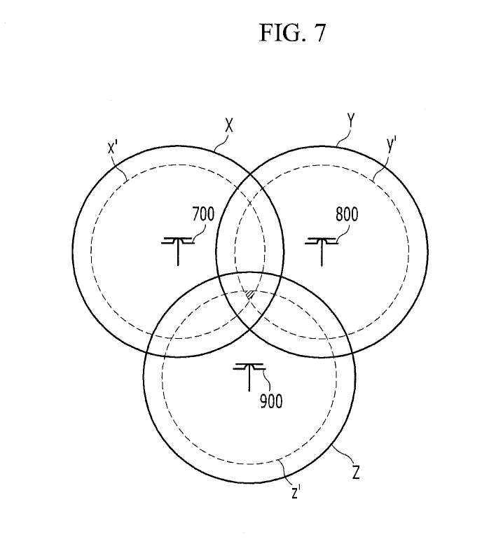

FIG. 7 is a view illustrating a method for estimating the location of a receiver by a wireless positioning apparatus according to an exemplary embodiment of the present invention.

With reference to FIG. 7, it is assumed that a receiver 600 knows about the locations of the transmitters 700, 800, and 900.

The wireless positioning apparatus calculates the distance between each of the transmitters 700, 800, and 900 and the receiver 600 by using an arrival time of the first reached propagation delay tap among propagation delay taps of reference signals received from the respective transmitters 700, 800, and 900, and forms circles X, Y, and Z around the transmitters 700, 800, and 900 on the basis of the center of each of the transmitters 700, 800, and 900 and having the distance between each of the transmitters 700, 800, and 900 and the receiver 600 as a radius.

Meanwhile, the wireless positioning apparatus calculates the weight of each of the transmitters and reduces the distance between each of the transmitters 700, 800, and 900 and the receiver 600 according to the ratio of the weight.

The adjustment of the distance according to the ratio of the weight value may be repeatedly performed until such time as the distance adjusted between the receiver and each of the transmitters, which is equivalent to the radius, converges into a point. Alternatively, the adjustment of the distance according to the ratio of the weight value may be repeatedly performed until such time as the area, in which the circles overlap with each other, becomes smaller than a certain range.

In the above description, it is assumed that the receiver receives reference signals for positioning from three transmitters for the sake of brevity, but the technical idea of the present invention is not meant to be limited thereto. The receiver may receive reference signals for positioning from three or more transmitters, and perform positioning on the basis of the received reference signals.

By performing wireless positioning on the basis of the types of the propagation delay taps, an error of wireless positioning caused when the propagation environment is the NLOS environment can be reduced.

According to the wireless positioning method and apparatus according to the exemplary embodiments of the present invention, a positioning error in an NLOS environment can be minimized. Thus, accurate positioning results can be obtained by using wireless communication even in a satellite reception is not easy.

The exemplary embodiments of the present invention are not implemented only through the apparatus and method, but can be implemented through a program realizing the function corresponding to the configurations of the exemplary embodiments of the present invention or a recording medium storing the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A wireless positioning method of a receiver, the method comprising:
receiving signals from a plurality of transmitters;
determining a propagation delay tap of each of the plurality of transmitters received from the plurality of transmitters, respectively;
calculating the distance between the receiver and each of the transmitters, respectively;
calculating the weight of each of the transmitters by using each of the propagation delay taps;
adjusting each of the distances by using each of the weights; and
estimating an area, in which circles away by the adjusted distances between the receiver and each of the transmitters on the basis of each of the transmitters overlap with each other, as the location of the receiver.

2. The method of claim 1, wherein each of the weights is calculated by using the delay spread value of each of the transmitters.

3. The method of claim 2, wherein each of the weights is calculated further by using a signal strength of each of the taps of the transmitters.

4. The method of claim 2, wherein the delay spread value of each of the transmitters is the difference between an arrival time of the first reached propagation delay tap and that of the latest reached propagation delay tap, among the propagation delay taps of the respective transmitters.

5. The method of claim 1, wherein the calculating of the distance comprises:
calculating the distance by using the arrival time of the propagation delay tap which has first arrived among the propagation delay taps of the respective transmitters.

6. A wireless positioning method of a receiver, the method comprising:
receiving signals from a plurality of transmitters;
determining a propagation delay tap of each of the plurality of transmitters received from the plurality of transmitters;
calculating the distance between the receiver and each of the transmitters, respectively, by using an arrival time of a first reached propagation delay tap among the propagation delay taps of the respective transmitters; and
determining the location of the receiver by using the distance and a delay spread value.

7. The method of claim 6, wherein the delay spread value is the difference between an arrival time of a first reached propagation delay tap and that of the latest reached propagation delay tap, among the propagation delay taps of the respective transmitters.

8. The method of claim 7, wherein the determining of the location of the receiver comprises:
calculating the weight of each of the transmitters by using the delay spread value;
correcting the distance by using the weight of each of the transmitters; and
when an area, in which the circles away by the corrected distance overlap with each other, narrows to come within a certain range, determining the overlap area as the location of the receiver.

9. The method of claim 8, wherein the weight is calculated by using a signal strength of the propagation delay tap of each of the transmitters.

10. The method of claim 8, wherein the correcting of the distance comprises:
reducing the distance between the receiver and each of the transmitters in the rate of the weight of each of the transmitters.

11. The method of claim 10, wherein, the reducing of the distance is repeatedly performed until such time as the overlap area narrows to come within the certain range.

12. A wireless positioning apparatus of a receiver, the apparatus comprising:
a signal receiving unit configured to receive signals from a plurality of transmitters;
a propagation delay tap determining unit configured to determine propagation delay taps of the plurality of transmitters received from the plurality of transmitters;
a distance calculation unit configured to calculate the distance between the receiver and each of the transmitters, respectively;
a weight calculation unit configured to calculate the weight of each of the transmitters by using the propagation delay taps; and
a location determining unit configured to adjust the distances by using the weights, and estimate an area, in which circles away by the adjusted distances between the receiver and each of the transmitters on the basis of each of the transmitters overlap with each other, as the location of the receiver.

13. The apparatus of claim 12, wherein the distance calculation unit calculates the distance by using an arrival time of the first reached propagation delay tap among the propagation delay taps of the respective transmitters.

14. The apparatus of claim 12, wherein the weight calculation unit calculates the weight of each of the transmitters by using a delay spread value of each of the transmitters.
